(19) United States
(12) Patent Application Publication
(10) Pub. No.: US 2003/0103600 A1
(43) Pub. Date: Jun. 5, 2003

(54) Telephone answering device with special outgoing message capabilities

(76) Inventor: Danny E. Potter, Grand Prairie, TX (US)

Correspondence Address: Lawrence R. Youst, Smith, Danamraj & Youst, P.C., Suite 1200, LB 15, 12900 Preston Road, Dallas, TX, 75230-1328, US

(21) Appl. No.: 10/002,689

(22) Filed: Dec. 5, 2001

(51) Int. Cl. H04M 1/64

(52) U.S. Cl. 379/67.1; 379/88.22

(57) ABSTRACT

A telephone answering device (“TAD”) (10) is disclosed that enables a user to record a general outgoing message, which is played to all callers upon receipt by the TAD (10) of an incoming call on a telephone line (14), and one or more special outgoing messages, each of which is played only in response to receipt by the TAD (10) of a code associated with the special outgoing message. The TAD (10) comprises a control circuit (12) connectable to the telephone line (14) and a storage medium (16) connected to the control circuit (12) for storing the general outgoing message, the special outgoing messages and the incoming messages.

### TECHNICAL FIELD OF THE INVENTION

This invention relates, in general, to telephone answering devices (“TADs”) and, in particular, to a TAD having special messaging capabilities to enable a user to leave a private message for one or more preselected callers or groups of callers.

### BACKGROUND OF THE INVENTION

Without limiting the scope of the present invention, its background will be described with reference to a TAD having special messaging capabilities.

Conventional TADs are designed such that only one prerecorded outgoing message (“OM”) is played back to a caller upon the TAD's answering an incoming call. Such OMs are typically very general messages informing the caller that the called party is unavailable and inviting the caller to leave a message.

It will be recognized that there are situations in which a called party may want to inform a particular caller or group of callers of more specific information. For example, if the called party is out of town for a week, he or she may want to inform a select group of people of that fact, but, for obvious reasons, certainly would not want to include that information on the general OM.

Voice mail systems do exist in which a call is routed within the system based on caller ID information transmitted with an incoming call. For example, U.S. Pat. No. 5,347,574 to Morganstein (hereinafter “Morganstein”) discloses a method for facilitating call completion wherein, upon receipt of an incoming call, a call processor matches the caller ID information associated with the call with a preprogrammed number and completes the call according to the programmed destination. This system fails to accomplish the above-stated purpose, in that in some cases, caller ID information is not available. Also, it is possible that the intended recipient of the special message is calling from a phone other than one typically associated with the caller or that a party other than the intended recipient of the special OM is calling from a telephone typically associated with the intended recipient. In the first situation, the caller would not receive the message; in the second, someone other than the intended recipient would erroneously receive the message.

U.S. Pat. No. 4,850,005 to Hashimoto (hereinafter “Hashimoto”) discloses a TAD that uses artificial intelligence to provide a specific message to a caller. In the system disclosed by Hashimoto, an OM comprising a request for input is played to a caller upon receipt of an incoming call. Upon receipt of the requested input, a second message is played. The content of the second message depends on whether the caller is “registered” with the system, in which case a caller-specific message will be played, or not, in which case a generic message will be played. Thus, in the system of Hashimoto, each caller will always be played two OMs, the first of which prompts him or her to enter requested information and the second of which will be either general or specific, depending on the information provided by the caller in response to the first message.

Neither the system of Morganstein nor the system of Hashimoto addresses the need of a called party to cause a TAD to play only a general OM, typically comprising greeting and invitation to a caller to leave a message, to all callers and to play a special OM comprising more personal or detailed information for one or more select callers.

Therefore, what is needed is a TAD that, after issuance of a general OM to a caller, is capable of providing a more specific OM to the caller responsive to entry by the caller of a special code.

### SUMMARY OF THE INVENTION

The present invention disclosed herein comprises a telephone answering device designed to enable a user to record a general OM, or greeting, that is played to all callers upon receipt by the TAD of a call, and one or more special OMs, each of which is played only in response to receipt by the TAD of a code associated with the special OM.

In one embodiment, if there is a special OM recorded on the TAD, a special tone is played upon completion of the general OM to apprise the caller of that fact. Following completion of the general OM, the TAD will wait a predetermined period of time for receipt of a code before enabling the caller to record an incoming message. If a code is received, a determination is made whether it is associated with a special OM and, if so, the special OM is played, after which the caller may leave a message. If the code is not associated with a special OM and the predetermined time period has not yet expired, the caller may be prompted to enter a new code. Upon expiration of the predetermined time period without entry of a valid code, the caller's message will be recorded.

In this manner, private messages may be recorded by a user for playback only to one or more selected callers.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a block diagram of telephone answering device of one embodiment of the present invention;

FIG. 2 illustrates a random access memory (“RAM”) of a TAD of the present invention for storing greetings;

FIG. 3 is a flowchart of a PROGRAM mode of operation of a TAD of the present invention;

FIG. 4 is a flowchart of a PLAYBACK mode of operation of a TAD of the present invention;

FIG. 5 is a flowchart of an alternative embodiment of a PLAYBACK mode of operation of a TAD of the present invention;

FIGS. 6 and 7 collectively illustrate the contents of a RAM of a TAD of the present invention subsequent to implementation of an alternative embodiment of a PLAYBACK mode of operation; and

FIG. 8 illustrates the contents of a RAM of a TAD of the present invention subsequent to implementation of another alternative embodiment of a PLAYBACK mode of operation.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

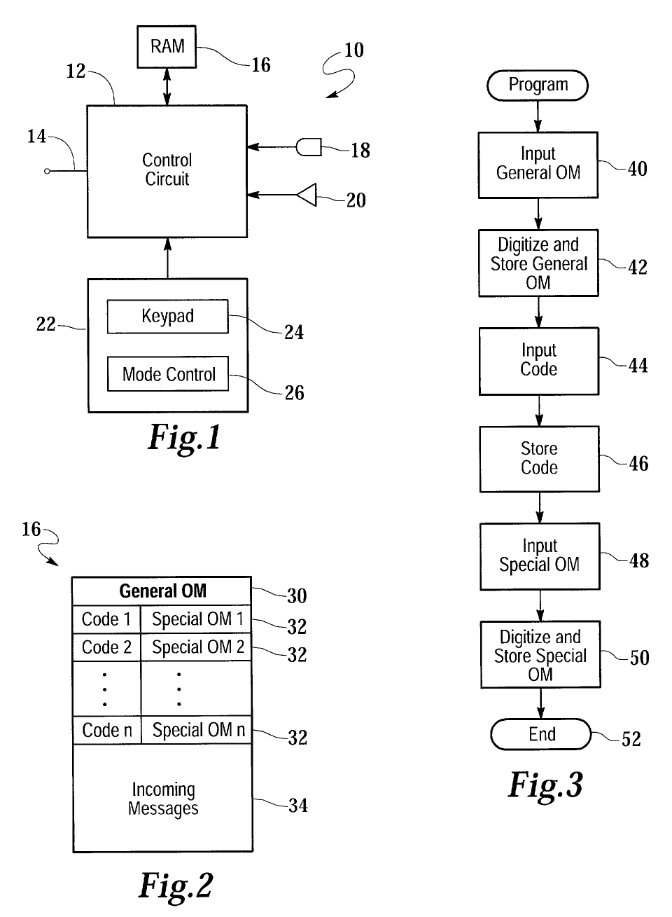

Referring now to FIG. 1, therein is depicted one embodiment of a TAD that, subsequent to playing a general OM to a caller, is capable of playing a special OM in response to receipt of a code associated with the special OM.

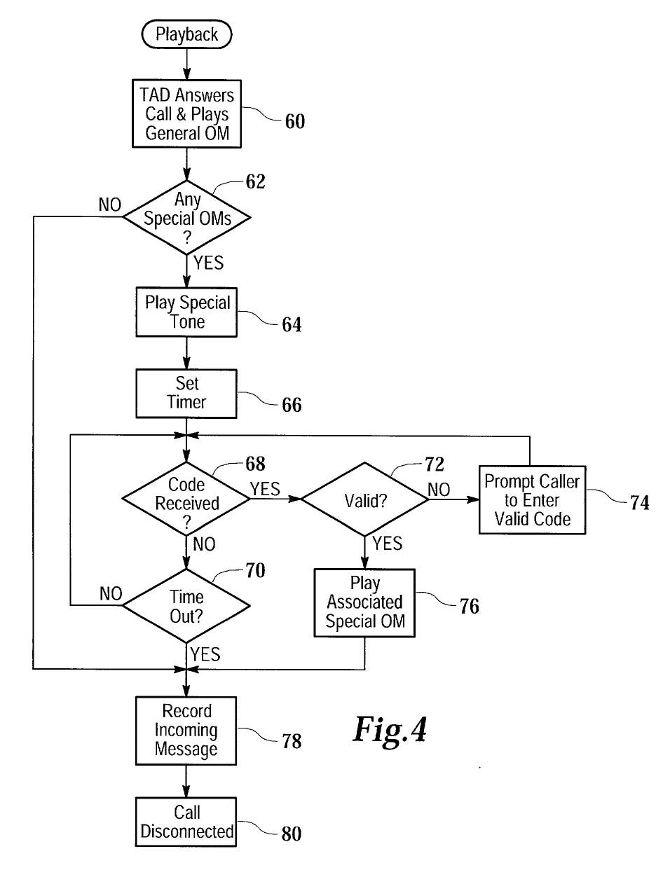

In FIG. 1, a TAD embodying features of one embodiment is designated generally by a reference numeral 10. As shown in FIG. 1, TAD 10 includes a control circuit 12 connected to a telephone line 14, random access memory (“RAM”) 16, a microphone 18 and a speaker 20. TAD 10 further comprises a control panel 22 that includes a circuit for generating codes, which in one embodiment is a conventional touch-tone keypad 24 for generating dual-tone multi-frequency (“DTMF”) tones, and a mode control switch 26 for controlling the mode of operation (e.g., “PROGRAM” and “PLAYBACK”) of TAD 10. As will be described in detail below, the control circuit 12 includes appropriate circuitry and components for monitoring the condition (i.e., on-hook or off-hook) of and detecting incoming calls on telephone line 14 and for controlling the operation of TAD 10 to enable the functions described in FIGS. 3 and 4.

As will be described in greater detail below with reference to FIGS. 2 and 3, when TAD 10 is set to operate in PROGRAM mode, control circuit 12 generally enables OMs input using microphone 18 to be stored at appropriate locations in RAM 16. As will also be described in greater detail below with reference to FIG. 4, in PLAYBACK mode, control circuit 12 generally detects an incoming call on line 14, plays one or more of the OMs recorded in RAM 16, and records an incoming voice message spoken by a caller in response to the OM(s).

FIG. 2 illustrates the contents of RAM 16 in accordance with one embodiment of the present invention. As shown in FIG. 2, RAM 16 includes a general OM storage location 30 for storing a general OM, n special OM storage locations 32 for storing up to n codes and associated special messages, and an incoming message storage area 34 comprising multiple storage locations for storing incoming messages recorded by callers. Alternatively, incoming message storage area 34 may be partitioned such that incoming messages for callers that hear only the general OM are stored in one area while incoming messages for callers that hear a special OM are stored in a separate area. It should be noted that RAM 16 may comprise one or more separate RAM devices. Alternatively, the functions of RAM 16 may be implemented using other types of storage media, such as one or more magnetic tapes or other digital storage media.

Referring collectively to FIGS. 1-3, the PROGRAM mode of operation of TAD 10 will be described in greater detail. In step 40, a user inputs a general OM by speaking into microphone 18. A typical general OM will inform the caller that the called party is not available and invite the caller to leave a message (e.g., “I am not able to answer the phone at the present time. Please leave a message after the tone.”). In step 42, the general OM is digitized by control circuit 12 and stored in the general OM storage location 30 of RAM 16. In step 44, the user inputs a code. In a preferred embodiment, the code input in step 44 is a two-digit DTMF code generated by depressing keys of keypad 24; however, it should be noted that other code forms (e.g., three-digit or spoken) may be employed. In step 46, the code is stored in a first portion of one of the special OM storage locations 32.

In step 48, the user records a special OM to be associated with the code entered in step 44. A special OM will typically include information of a more personal or private nature (e.g., “I have gone to the doctor's office for a 10:00 appointment and will be home around noon.”) intended to be heard only by one or more specific callers. In step 50, the special OM is digitized by control circuit 12 and stored in a second portion of one of the special OM storage locations 32 in which the associated code is stored.

Steps 40-50 are then repeated until all of the code/special OM combinations have been input or until all of the special OM storage locations 32 are full. Execution of the PROGRAM mode terminates in step 52 when the user switches the mode control switch from PROGRAM to some other position (e.g., PLAYBACK).

Once TAD 10 is programmed as described above, it is ready for use. At this point, it is anticipated that the user will distribute the stored codes to friends and family members for whom he has recorded special OMs. The same code may be given to more than one person, if the message is intended to be heard by several persons. Alternatively, the user could “preassign” codes to certain friends and family members, and then use those codes as necessary when subsequently programming TAD 10 as described above.

In an alternative embodiment, the codes may be “prewired”, with the user only being able to select one of the prewired codes and record an associated special OM, in which case step 46 may be omitted and replaced by a step of locating the code entered in 44 and then storing the special OM in association with the selected code in steps 48 and 50. In this alternative embodiment, there may also be steps for checking whether the selected code is a valid code (i.e., one of the prewired codes) and prompting the user to enter a valid code if the selected code is not valid.

PLAYBACK mode of operation of TAD 10 will now be described with reference to FIGS. 2 and 4. Responsive to detection of an incoming call on line 14, in step 60, control circuit 12 answers the call and initiates playback of the general OM recorded in general OM storage location 30. In step 62, a determination is made whether any special OMs have been recorded in RAM 16. If so, execution proceeds to step 64, in which a special tone is played, thereby alerting a caller who is in possession of a code for accessing special OMs that there may be a special OM to be retrieved.

In step 66, a time-out timer, which may be implemented in software, is set to expire within a predetermined period of time. For reasons that will become more apparent, the selected time period should be sufficient to enable a caller to enter his or her code, but not so long as to significantly delay enabling the caller to record a message if the caller is not in possession of a valid code.

In step 68, a determination is made whether a code has been received over line 14. For example, if, as described above, the codes are two-digit DTMF tones, the caller will enter the code using the keys of his or her telephone. If it is determined in step 68 that a code has not been received, execution proceeds to step 70, in which a determination is made whether the time-out timer has timed out. If it is determined that the timer has not timed out, execution returns to step 68.

If it is determined in step 68 that a code has been received, execution proceeds to step 72, in which a determination is made whether the received code is associated with a special OM. This can be performed by comparing the received code with each of the codes stored in the first portions of storage locations 32. If the received code is not associated with a special OM, the caller may be prompted, in optional step 74, to reenter a code, at which point, execution returns to step 68. If in step 72, it is determined that the received code is associated with a special OM, in step 76, the special OM associated with the code is played to the caller over line 14.

Execution then proceeds to step 78, in which the caller's message, if any, is recorded by control circuit 12 in incoming message storage area 34 in a conventional fashion. Similarly, if in step 62 it is determined that there are no special OMs or if in step 70 it is determined that the timer has timed out, execution proceeds directly to 78. Execution ends in step 80 when the call is disconnected, either after the caller's message has been recorded or by the caller's telephone going on-hook.

It should be noted that steps 62 and 64 are optional steps and that execution may proceed directly from step 60, in which the general OM is played to the caller, to step 68 in which TAD 10 awaits input of a code. Alternatively, the tone may be a feature that may be selectively enabled and disabled by the user, such as by a switch provided on control panel 22, in which case step 62 would be replaced by a step of determining whether the special tone was enabled and, if so, playing the special tone.

Similarly, step 74, in which the user is prompted to reenter a code upon a determination that the code that was entered is not valid, is also optional and that execution may return directly to step 68 or may proceed directly to step 78 without giving the caller another chance to enter a code responsive to a determination in step 72 that the code received does not correspond to a special OM. If a prompt is provided, it may indicate that the code entered is not valid or that there is no message associated with the code. In addition, recording a prompt to be stored in and replayed from RAM 16 could form a part of the PROGRAM mode of operation described with reference to FIG. 3.

In the above-described manner, a user may record special OMs to be played only to callers in possession of an associated special code and be assured that those special OMs are in fact only heard by the designated callers. In operation, the user may issue the same code to several callers, thereby enabling operation of the TAD in a “bulletin board” fashion; alternatively, the user may issue different codes to different callers and record a different message for each of the issued codes, thereby enabling the user to get different messages to different callers.

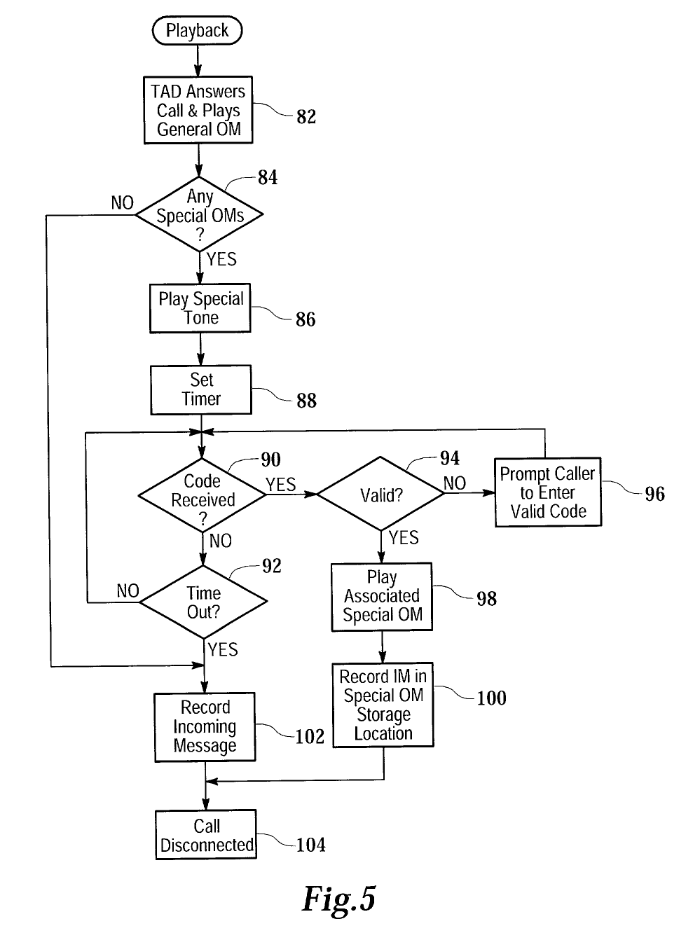

In another alternative embodiment, which will be described with reference to FIGS. 2 and 5, a message thread can be created between the called party and a caller to enable private communications between the parties. Referring to FIG. 5, the initial operation of the alternative embodiment is identical to that illustrated in FIG. 4. Specifically, steps 82-96 of FIG. 5 are identical and performed in a manner identical to steps 60-74 of FIG. 4 and will therefore not be discussed in greater detail. Beginning with step 98, the message associated with the code received in step 90 is played to the caller. Once the associated message is played, execution proceeds to step 100, in which the incoming message is stored in a second portion of one of the special OM storage locations 32 in which the received code is stored, thus overwriting any messages previously stored therein.

If in step 84 it is determined that no special OMs have been recorded or if in step 92 it is determined that the time-out timer has timed out, execution proceeds to step 102, in which the incoming message is recorded in the incoming message storage area 34 of the RAM 16. Once the incoming message is recorded in either step 100 or 102, the call is disconnected in step 104.

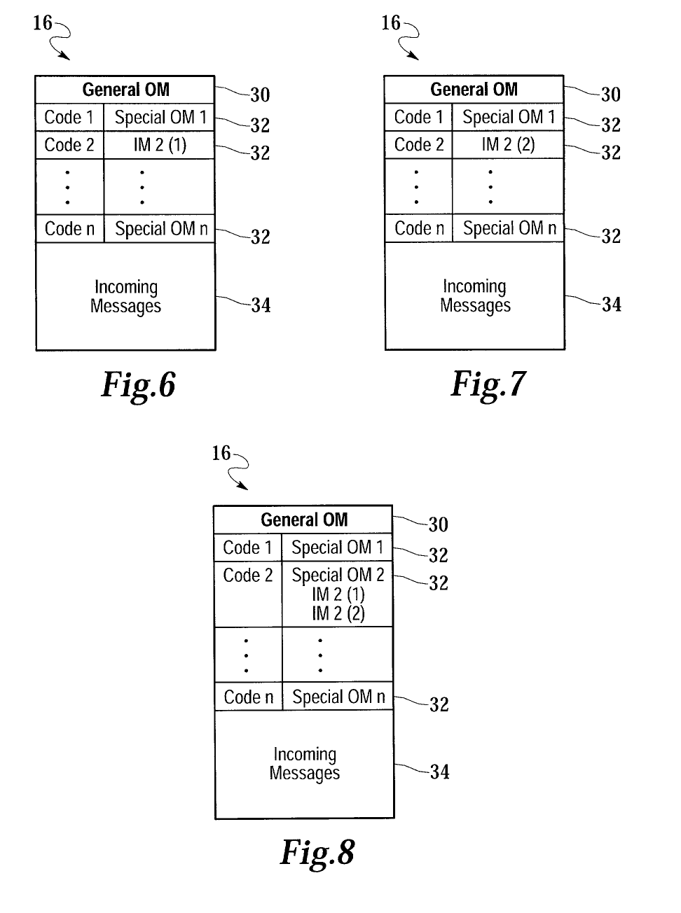

An example of this alternative embodiment will be illustrated with reference to FIGS. 2, 6 and 7. FIG. 2 represents the contents of the RAM 16 immediately after initial programming thereof using the method shown and described with reference to FIG. 3. At this point, it will be assumed that a caller having possession of Code 2 calls the user, inputs the code at the appropriate time and in the appropriate manner, is played the special message associated with Code 2 (Special OM 2), and then leaves a message in response thereto. FIG. 6 illustrates the contents of the RAM 16 after the caller has completed his or her message. Specifically, as will be noted by comparing FIG. 2 with FIG. 6, the Special OM 2 has been replaced with the caller's incoming message, designated in FIG. 6 as “IM 2(1)”.

At this point, it will be assumed that another caller, perhaps the user, calls and enter the same code (Code 2) at the appropriate time, at which point IM 2(1), rather than Special OM 2, will be played to the caller in step 100. Assuming further that this subsequent caller also leaves a message, this new incoming message, designated IM 2(2), will be recorded over IM 2(1), as illustrated in FIG. 7. In this manner, a message thread can be established between two or more parties using TAD 10 illustrated in FIG. 1.

It should be noted that it is also possible that, rather than replacing a previous message with a subsequent message, as described and illustrated with reference to FIGS. 5-7, that subsequent messages could be recorded prior or subsequent to previously recorded messages, such that each caller who enters the associated code would be played the entire message thread sequence of messages, either in first-in, first-out, or last-in, first-out order. This feature is illustrated in FIG. 8 using the above-described example in which two incoming messages, IM 2(1) and IM 2(2), associated with Code 2 are recorded by subsequent callers. Additionally, TAD 10 may enable a caller to skip any of the messages in the associated message thread sequence by, for example, pressing a designated key or keys of the caller's telephone, such that the caller could select the message or messages he or she wishes to review or skip.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A method of operating a telephone answering device connected to a telephone line, the method comprising:
answering an incoming call on the telephone line;
playing a general outgoing message on the telephone line; and
responsive to receipt on the telephone line of a code associated with a special message storage location, playing a message stored in the special message storage location on the telephone line.

2. The method as recited in claim 1 further comprising, responsive to expiration of a predetermined period of time without receipt on the telephone line of the code associated with the special message storage location, recording an incoming message received on the telephone line.

3. The method as recited in claim 1 further comprising, subsequent to playing the message stored in the special message storage location on the telephone line, recording an incoming message received on the telephone line.

4. The method as recited in claim 1 further comprising, subsequent to playing the message stored in the special message storage location, storing an incoming message received on the telephone line in the special message storage location.

5. The method as recited in claim 4 wherein more than one message is stored in the special message storage location, the method further comprising enabling a caller to select one or more of the more than one message to be played on the telephone line.

6. The method as recited in claim 1 further comprising, subsequent to playing the message stored in the special message storage location, replacing the message stored in the special message storage location with an incoming message.

7. The method as recited in claim 1 further comprising, subsequent to the playing a general outgoing message on the telephone line, playing a special tone on the telephone line if a special outgoing message has previously been recorded.

8. The method as recited in claim 1 wherein the code comprises at least one dual-tone multi-frequency tone.

9. A telephone answering device connectable to a telephone line comprising:
means for answering an incoming call on the telephone line;
means for playing a general outgoing message on the telephone line; and
means responsive to receipt on the telephone line of a code associated with a special message storage location for playing a message stored in the special message storage location on the telephone line.

10. The telephone answering device as recited in claim 9 further comprising means responsive to expiration of a predetermined period of time without receipt on the telephone line of the code associated with the special message storage location for recording an incoming message received on the telephone line.

11. The telephone answering device as recited in claim 9 further comprising means for recording an incoming message received on the telephone line subsequent to playing the messages stored in the special message storage location on the telephone line.

12. The telephone answering device as recited in claim 9 further comprising means for storing an incoming message received on the telephone line in the special message storage location subsequent to playing the message stored in the special message storage location.

13. The telephone answering device as recited in claim 12 wherein more than one message is stored in the special message storage location and wherein the telephone answering device further comprises means for enabling a caller to select among the more than one message to be played on the telephone line.

14. The telephone answering device as recited in claim 9 further comprising means for replacing the message stored in the special message storage location with an incoming message subsequent to playing the message stored in the special message storage location.

15. The telephone answering device as recited in claim 9 further comprising means for playing a special tone on the telephone line if a special outgoing message has previously been recorded subsequent to the playing a general outgoing message on the telephone line.

16. The telephone answering device as recited in claim 9 wherein the code comprises at least one dual-tone multi-frequency tone.

17. A telephone answering device comprising:
a control circuit connectable to a telephone line; and
a storage medium connected to the control circuit that stores a general outgoing message, a special outgoing message and incoming messages, wherein, responsive to receipt of an incoming call on the telephone line, the control circuit answers the call, plays the general outgoing message on the telephone line, and, responsive to receipt of a code corresponding to the special outgoing message, plays the special outgoing message on the telephone line.

18. The telephone answering device as recited in claim 17 wherein the control circuit causes a special tone to be played subsequent to playing the general outgoing message if the special outgoing message is stored on the storage medium.

19. The telephone answering device as recited in claim 17 wherein the control circuit causes an incoming message to be stored on the storage medium subsequent to playing the special outgoing message on the telephone line.

20. The telephone answering device as recited in claim 17 wherein, subsequent to playing the general outgoing message and responsive to passage of a predetermined period of time without receipt of a special code, the control circuit causes an incoming message to be stored on the storage medium.

21. The telephone answering device as recited in claim 17 wherein the code comprises at least one dual-tone multi-frequency tone.

22. The telephone answering device as recited in claim 17 wherein the storage medium comprises random access memory.

23. The telephone answering device as recited in claim 17 wherein the storage medium comprises at least one magnetic tape.

24. The telephone answering device as recited in claim 17 wherein the storage medium comprises a digital storage medium.

25. A method of programming a telephone answering device connectable to a telephone line, the method comprising:
recording a general outgoing message;
inputting a code; and
recording a special outgoing message associated with the code such that upon receipt of an incoming call on the telephone line, the telephone answering device answers the incoming call, plays the general outgoing message on the telephone line, and, responsive to receipt on the telephone line of the code, plays the special outgoing message on the telephone line.

26. The method as recited in claim 25 wherein the code comprises at least one dual-tone multi-frequency tone.

27. The method as recited in claim 26 wherein the step of inputting a code further comprises inputting the code using a keypad of the telephone answering device.

28. A method of operating a telephone answering device connected to a telephone line, the method comprising:
answering an incoming call on the telephone line;
playing a general outgoing message on the telephone line;
subsequent to playing the general outgoing message, determining whether a code corresponding to a special outgoing message has been received on the telephone line; and
responsive to a determination that the code corresponding to the special outgoing message has been received on the telephone line, playing the special outgoing message on the telephone line.

29. The method as recited in claim 28 further comprising recording an incoming message received on the telephone line after playing the special outgoing message on the telephone line.

30. The method as recited in claim 28 further comprising, subsequent to playing the general outgoing message, determining whether a predetermined time period has expired and, responsive to expiration of the predetermined time period, recording an incoming message received on the telephone line.

31. The method as recited in claim 28 further comprising, subsequent to the playing of the general outgoing message on the telephone line, playing a special tone on the telephone line if the special outgoing message has previously been recorded.

32. The method as recited in claim 28 wherein the code comprises at least one dual-tone multi-frequency tone.
